(19) United States
(12) Patent Application Publication
(10) Pub. No.: US 2010/0214245 A1
(43) Pub. Date: Aug. 26, 2010

(54) INPUT APPARATUS, INPUT DISPLAY APPARATUS, AND ELECTRONIC DEVICE

(75) Inventor: Takenori HIROTA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/701,889

(22) Filed: Feb. 8, 2010

(30) Foreign Application Priority Data
Feb. 26, 2009 (JP) 2009-043559

(51) Int. Cl. G06F 3/041

(52) U.S. Cl. 345/173

(57) ABSTRACT

An input apparatus includes a single light-transmissible substrate, an input unit including a coordinate input surface formed upon one surface of the light-transmissible substrate, and an illumination unit formed upon the other surface of the light-transmissible substrate.

### BACKGROUND

1. Technical Field

The present invention relates to an input apparatus, an input display apparatus, and an electronic device, and particularly relates to an input apparatus, an input display apparatus, and an electronic device provided with an input unit and an illumination unit.

2. Related Art

An input display apparatus provided with an input unit and an illumination unit has been previously known (for example, see JP-A-11-344695). The input display apparatus disclosed in the aforementioned JP-A-11-344695 includes a touch panel through which a viewer can make inputs (that is, an input unit), an illumination unit, provided separately from the input unit, that has a light source configured of an LED or the like provided on the side of the touch panel opposite to the viewer side and a light guide plate for guiding the light from the light source, and a reflective liquid-crystal display provided on the side of the light source opposite to the viewer side (that is, a display unit). This input display apparatus configured by layering the three elements, or in other words, the touch panel, the illumination unit, and the reflective liquid-crystal display. Furthermore, the light source of the illumination unit is provided at the end of the illumination unit. The light emitted from the light source is diffused within the light guide plate, and the reflective liquid-crystal display is irradiated with some of that light. The irradiated light is reflected by the reflective liquid-crystal display, thereby realizing a reflected display upon the reflective liquid-crystal display.

However, with the input display apparatus disclosed in the aforementioned JP-A-11-344695, the touch panel and illumination unit are provided separately, resulting in an issue in that the thickness of the input display apparatus increases by that amount. Accordingly, there is a problem in that it is difficult to realize a thinner apparatus.

### SUMMARY

An advantage of some aspects of the invention is to provide an input apparatus, an input display apparatus, and an electronic device capable of realizing a thinner configuration.

An input apparatus according to a first aspect of the invention includes: an input unit that has a coordinate input surface; an illumination unit provided on the side of the input unit that is opposite to the side on which the coordinate input surface is provided; and a light-transmissible substrate, capable of allowing light to pass therethrough, provided at the border between the input unit and the illumination unit so that the light-transmissible substrate is shared between the input unit and illumination unit.

In the input apparatus according to the first aspect of the invention, the light-transmissible substrate capable of allowing light to pass therethrough is provided at the border between the input unit and the illumination unit so that the light-transmissible substrate is shared between the input unit and illumination unit, as described above; therefore, for example, the input unit is configured on one side of the light-transmissible substrate and the illumination unit is configured on the other side of the light-transmissible substrate, thus making it possible to realize a configuration in which the input unit and the illumination unit are integrated. Accordingly, the total thickness of the input unit and the illumination unit decreases, as opposed to a case in which an input unit and an illumination unit configured separately are simply layered; this makes it possible to suppress an increase in the total thickness of the input unit and the illumination unit. It is therefore possible to realize a thinner configuration for the apparatus.

It is preferable, in the input apparatus according to the aforementioned first aspect of the invention, for the illumination unit to include: a first electrode layer formed upon the light-transmissible substrate, which is shared with the input unit, on the side opposite to the side of the input unit; a light-emitting layer formed so as to cover the first electrode layer; and a light-emitting element portion configured of a second electrode layer formed so as to cover the light-emitting layer; and for the light-emitting element portion to irradiate light as a result of a predetermined voltage being applied to the first electrode layer and the second electrode layer. According to this configuration, an integrated configuration can easily be realized using the light transmissible substrate that is shared between the input unit and the illumination unit that includes the light-emitting element portion.

In this case, it is preferable for the first electrode layer to be an anode layer, the second electrode layer to be a cathode layer, and the light-emitting layer to be an organic light-emitting layer, and for the light-emitting element portion to be an organic electroluminescence element configured of the anode layer, the organic light-emitting layer, and the cathode layer. According to this configuration, the input unit and the illumination unit that includes the organic electroluminescence element can be configured in an integrated manner.

It is preferable, in the input apparatus according to the aforementioned first aspect of the invention, for the input unit to include a third electrode layer formed upon the surface of the light-transmissible substrate, which is shared with the illumination unit, on the same side as the input unit; and a fourth electrode layer formed above the third electrode layer. According to this configuration, a touch panel can be formed from the third electrode layer, which is formed upon the surface of the light-transmissible substrate that is shared with the illumination unit on the same side as the input unit, and the fourth electrode layer; it is therefore easy to realize a configuration in which the illumination unit and the touch panel are integrated.

An input display apparatus according to a second aspect of the invention includes: an input apparatus that includes an input unit having a coordinate input surface, an illumination unit provided on the opposite side of the coordinate input surface of the input unit, and a light-transmissible substrate, capable of allowing light to pass therethrough, provided at the border between the input unit and the illumination unit so that the light-transmissible substrate is shared between the input unit and illumination unit; and a display unit, provided on the opposite side of the coordinate input surface of the input apparatus, configured so as to be capable of a reflective display by reflecting, toward the coordinate input surface, the light irradiated from the illumination unit.

According to this configuration, with the input display apparatus according to the aforementioned second aspect of the invention, it is possible to realize an integrated configuration of the input unit and the illumination unit in the input apparatus. Accordingly, the total thickness of the input unit and the illumination unit decreases, which makes it possible to suppress an increase in the total thickness of the input unit and the illumination unit. Furthermore, by sharing the light-transmissible substrate between the input unit and the illumination unit of the input apparatus, the number of border surfaces between input unit and illumination unit can be reduced, which makes it possible to execute a reflective display using the display unit while suppressing light irradiated from the illumination unit from reflecting or refracting at the border surfaces between the input unit and illumination unit.

In this case, it is preferable for the input display apparatus to further include a bonding layer for bonding the illumination unit and the display unit to each other, for the shared light-transmissible substrate to include a glass substrate, and for the bonding layer to have a refraction index that is approximately the same as the refraction index of the glass substrate. According to this configuration, the light that passes through the bonding layer and the glass substrate can be suppressed from refracting at the border surface between the bonding layer and the glass substrate.

An electronic device according to a third aspect of the invention includes an input apparatus having one of the configurations described above. According to such a configuration, it is possible to achieve an electronic device that includes an input apparatus capable of realizing a thinner configuration.

An electronic device according to a fourth aspect of the invention includes an input display apparatus having one of the configurations described above. According to such a configuration, it is possible to achieve an electronic device that includes an input display apparatus capable of realizing a thinner configuration.

### BRIEF DESCRIPTION OF THE DRAWINGS

The invention will be described with reference to the accompanying drawings, wherein like numbers reference like elements.

FIG. 1 is a cross-section illustrating an input display apparatus according to a first embodiment of the invention.

FIG. 2 is a cross-section viewed along the 650-650 line shown in FIG. 1.

FIG. 3 is a cross-section viewed along the 700-700 line shown in FIG. 1.

FIG. 4 is a cross-section illustrating an input display apparatus according to a second embodiment of the invention.

FIG. 5 is a cross-section viewed along the 800-800 line shown in FIG. 4.

FIG. 6 is a diagram illustrating a first example of an electronic device that uses the input display apparatus according to the first and second embodiments of the invention.

FIG. 7 is a diagram illustrating a second example of an electronic device that uses the input display apparatus according to the first and second embodiments of the invention.

FIG. 8 is a diagram illustrating a third example of an electronic device that uses the input display apparatus according to the first and second embodiments of the invention.

FIG. 9 is a diagram illustrating a variation of the input display apparatus according to the first embodiment of the invention.

### DESCRIPTION OF EXEMPLARY EMBODIMENTS

Hereinafter, embodiments of the invention will be described based on the drawings.

### First Embodiment

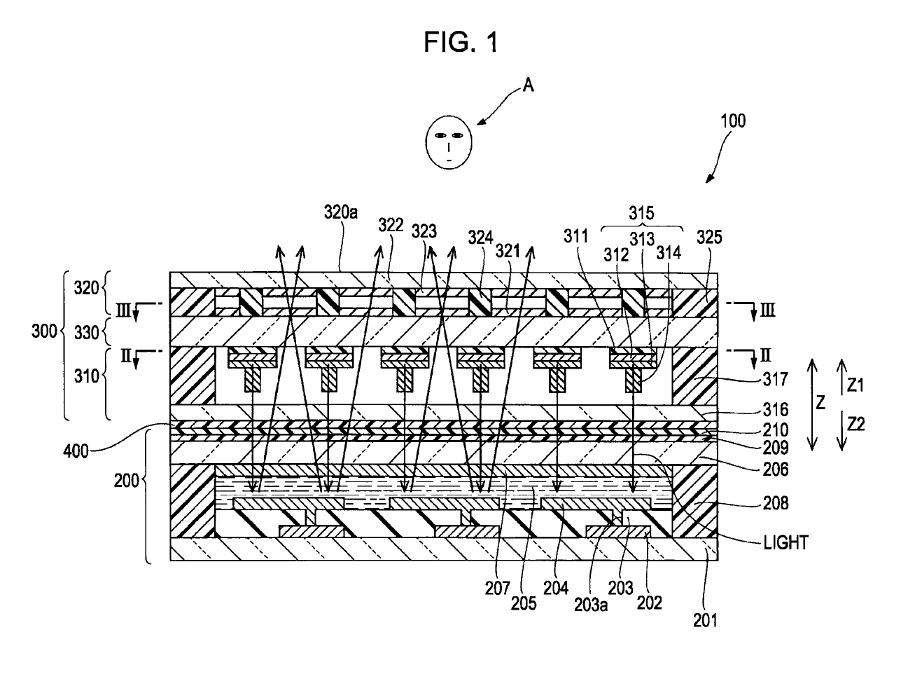

Hereinafter, the configuration of an input display apparatus (display apparatus) 100 according to a first embodiment of the invention will be described with reference to FIGS. 1 through 3.

As shown in FIG. 1, the input display apparatus 100 according to the first embodiment includes a reflective liquid-crystal display unit 200 and a front-lit integrated touch panel 300. Note that the reflective liquid-crystal display unit 200 is an example of a “liquid-crystal display unit” according to the invention, and the front-lit integrated touch panel 300 is an example of an “input apparatus” according to the invention. The reflective liquid-crystal display unit 200 and the front-lit integrated touch panel 300 are bonded together by a bonding layer 400, which is configured of a light-curable or heat-curable resin.

The reflective liquid-crystal display unit 200 includes a TFT substrate 201 configured of a light-transmissible material such as glass or the like. Multiple TFTs (Thin-Film Transistors) 202, used for switching, are formed on the surface of the TFT substrate 201 in locations corresponding to multiple pixels (not shown) that are also provided upon the TFT substrate 201. In addition, an interlayer insulating film 203 is formed so as to cover the TFT substrate 201 and the TFTs 202. Contact holes 203a are formed in the interlayer insulating film 203 in locations corresponding to the sources (not shown) or the drains (not shown) of the TFTs 202. In addition, reflective pixel electrodes 204 configured of a reflective material such as Al (aluminum) are formed upon the surface of the interlayer insulating film 203 in locations corresponding to the multiple TFTs 202. Furthermore, each reflective pixel electrode 204 is electrically connected to the source or drain of a corresponding TFT 202 via a contact hole 203a.

A liquid-crystal layer 205 is provided above the reflective pixel electrodes 204, and an opposing substrate 206 configured of a light-transmissible material such as glass is disposed opposing the TFT substrate 201 so as to sandwich the liquid-crystal layer 205. A common electrode 207 configured of a transparent conductive material such as ITO (Indium Thin Oxide) is formed upon the surface of the opposing substrate 206 on the liquid-crystal layer 205 side (the side indicated by the arrow Z2). The TFT substrate 201 and the opposing substrate 206 are laminated together using a sealant 208 such as a resin so as to confine the liquid-crystal layer 205 therebetween.

Meanwhile, a light diffusing layer 209 configured of a diffusing adhesive layer is formed upon the surface of the opposing substrate 206 on the side opposite the side of the liquid-crystal layer 205 (the side indicated by the arrow Z1). This light diffusing layer 209 is provided to diffuse light that has been emitted from a front light 310 (described later) in the direction of the arrow Z2, thereby causing the reflective pixel electrodes 204 to be irradiated with a uniform light. In addition, a polarizer 210 is formed upon the surface of the light diffusing layer 209.

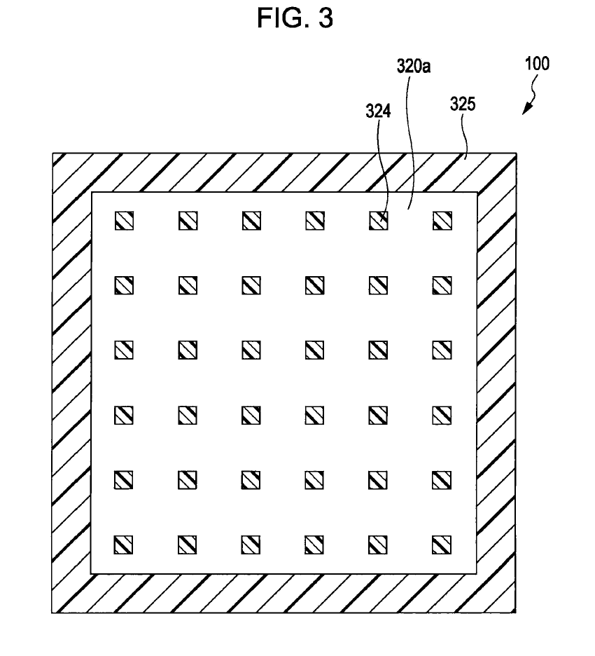

Here, in the first embodiment, the front-lit integrated touch panel 300 includes a front light 310 having top emission-type organic EL (electroluminescence) elements 315 (mentioned later), a resistive touch panel 320 that contains a coordinate input surface 320a (see FIG. 3), and a light-transmissible substrate 330 configured of glass or the like that allows light to pass through. The light-transmissible substrate 330 is disposed at the border between the touch panel 320 and the front light 310, and is shared by the touch panel 320 and the front light 310. Note that the front light 310 is an example of an “illumination unit” according to an aspect of the invention, and the resistive touch panel 320 is an example of an “input unit” according to an aspect of the invention. The front light 310 is formed on the side of the light-transmissible substrate 330 corresponding to the direction of the arrow Z2. The resistive touch panel 320, meanwhile, is formed on the side of the light-transmissible substrate 330 corresponding to the direction of the arrow Z1 (that is, on the side of a viewer A).

In the first embodiment, the refraction index of the light-transmissible substrate 330, which is configured of a glass substrate, is approximately the same as the refraction index of the bonding layer 400, which is configured of a light-curable or heat-curable acrylic resin or the like. For example, in the case where the refraction index of the light-transmissible substrate 330, which is configured of a glass substrate, is no less than 1.4 and no more than 1.5, the refraction index of the bonding layer 400, which is configured of an acrylic resin or the like, may be no less than 1.4 and no more than 1.6.

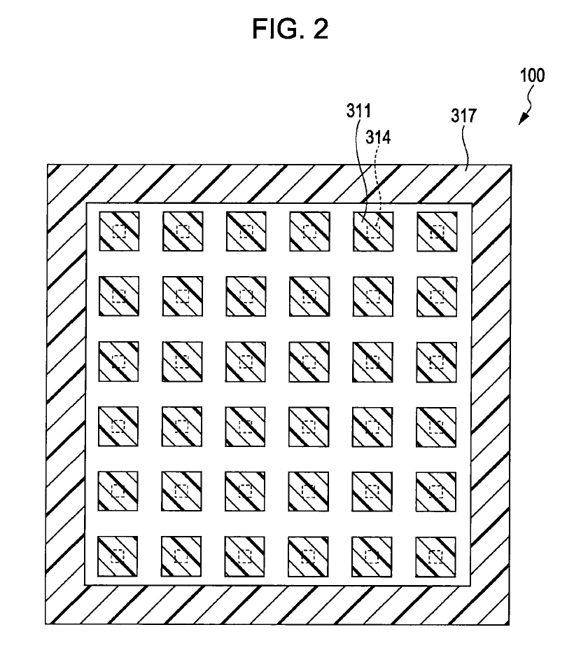

In the front light 310 that contains top emission-type organic EL elements, multiple light-blocking films 311 configured of a resin are formed on the rear surface side of the light-transmissible substrate 330 (the side corresponding to the direction of the arrow Z2), as shown in FIG. 1. These light-blocking films 311 are disposed in matrix form, as can be seen from the plan view illustrated in FIG. 2. Furthermore, as shown in FIG. 1, anode layers 312 configured of a transparent conductive material such as ITO are formed on the rear side of the light-blocking films 311. Note that the anode layers 312 are an example of a “first electrode layer” according to an aspect of the invention. Organic light-emitting layers 313 are formed on the rear side of the anode layers 312. Cathode layers 314 are formed on the rear side of the organic light-emitting layers 313. Note that the cathode layers 314 are an example of a “second electrode layer” according to an aspect of the invention. These cathode layers 314 are configured of gold (Au) or silver (Ag).

Furthermore, as can be seen from the plan view illustrated in FIG. 2, the cathode layers 314 are configured so that their surface area is less than the surface areas of the light-blocking films 311, the anode layers 312, and the organic light-emitting layers 313. A single top emission-type organic EL element 315 is configured from an anode layer 312, an organic light-emitting layer 313, and a cathode layer 314. The configuration is such so that light is emitted from the organic light-emitting layers 313 in the direction Z2 when a predetermined voltage is applied across the anode layers 312 and the cathode layers 314. Furthermore, the configuration is such that light emitted from the organic light-emitting layers 313 is reflected toward the viewer A by the reflective pixel electrodes 204 of the reflective liquid-crystal display unit 200. In addition, the transparent substrate 316 and the light-transmissible substrate 330 are bonded to each other using a sealant 317 configured of a resin or the like.

As shown in FIG. 1, in the resistive touch panel 320, a transparent electrode film 321 configured of a transparent conductive material such as ITO is formed on the surface of the light-transmissible substrate 330. Note that the transparent electrode film 321 is an example of a “third electrode layer” according to an aspect of the invention. This transparent electrode film 321 is formed as a thin film seen in the plan view in regions corresponding to the coordinate input surface 320a (see FIG. 3). Furthermore, a bendable transparent substrate 322 is disposed above the light-transmissible substrate 330 (in the direction corresponding to the arrow Z1) so as to oppose the light-transmissible substrate 330. A transparent electrode film 323 configured of a transparent conductive material such as ITO or the like is formed on the rear side of this transparent substrate 322. Note that the transparent electrode film 323 is an example of a “fourth electrode layer” according to an aspect of the invention. This transparent electrode film 323 is formed as a thin film seen in the plan view in regions corresponding to the coordinate input surface 320a (see FIG. 3).

Meanwhile, spacers 324 configured of a photosensitive acrylic resin or the like are formed between the light-transmissible substrate 330 and the transparent substrate 322. As can be seen in the plan view illustrated in FIG. 3, the spacers 324 are disposed in matrix form, and are also disposed so as to overlap with the organic EL elements 315 of the front light 310 shown in FIG. 1. Furthermore, the light-transmissible substrate 330 and the transparent substrate 322 are bonded to each other using a sealant 325 configured of a resin or the like.

The touch panel 320 is configured so that the transparent substrate 322 and the transparent electrode film 323 bend when the viewer A presses down upon the transparent substrate 322. When the transparent electrode film 323 makes contact with the surface of the transparent electrode film 321, electrical conductivity arises in the location where the transparent electrode film 323 and the transparent electrode film 321 make contact. The configuration is such that the location at which the viewer A has pressed down upon the coordinate input surface 320a can be detected by detecting the contact location using a detection unit (not shown).

As described above, in the first embodiment, a light-transmissible substrate 330 capable of allowing light to pass therethrough is provided at the border between the touch panel 320 and the front light 310 so as to be shared by the touch panel 320 and the front light 310; thus the touch panel 320 is configured on one side of the light-transmissible substrate 330 and the front light 310 is configured on the other side of the light-transmissible substrate 330, which makes it possible to realize a configuration in which the touch panel 320 and the front light 310 are integrated. Accordingly, the total thickness of the touch panel 320 and the front light 310 decreases, as opposed to a case in which a touch panel and a front light configured separately are simply layered; this makes it possible to suppress an increase in the thickness of the front-lit integrated touch panel 300. As a result, a thinner front-lit integrated touch panel 300 can be realized.

Furthermore, as described above, in the first embodiment, configuring each of the organic EL elements 315 from the anode layer 312, the organic light-emitting layer 313, and the cathode layer 314 makes it possible to realize the touch panel 320 and the front light 310 that contains the organic EL elements 315 as an integrated configuration.

Furthermore, as described above, in the first embodiment, configuring the touch panel 320 to include the transparent electrode film 321 formed upon the touch panel 320 side of the surface of the light-transmissible substrate 330, which is shared with the front light 310, and the transparent electrode film 323, which is formed above the third electrode, makes it possible to form a resistive touch panel 320 from the transparent electrode film 321, which is formed upon the touch panel 320 side of the light-transmissible substrate 330 that is shared between the touch panel 320 and the front light 310, and the transparent electrode film 323; therefore, it is easy to realize an integrated configuration of the front light 310 and the resistive touch panel 320.

Furthermore, as described above, in the first embodiment, providing a front-lit integrated touch panel 300 and a reflective liquid-crystal display unit 200 makes it possible to realize an integrated configuration of the touch panel 320 in the front-lit integrated touch panel 300 and the front light 310. Accordingly, the number of border surfaces between the front light 310 and the touch panel 320 can be reduced, which makes it possible to execute a reflective display using the reflective liquid-crystal display unit 200 while suppressing light irradiated from the front light 310 from reflecting or refracting at the border surfaces between the touch panel 320 and the front light 310.

Furthermore, as described above, in the first embodiment, the shared light-transmissible substrate 330 includes a glass substrate, and the bonding layer 400 has approximately the same refraction index as the glass substrate; therefore, the light that passes through the bonding layer 400 and the glass substrate can be suppressed from refracting at the border surface between the bonding layer 400 and the glass substrate.

### Second Embodiment

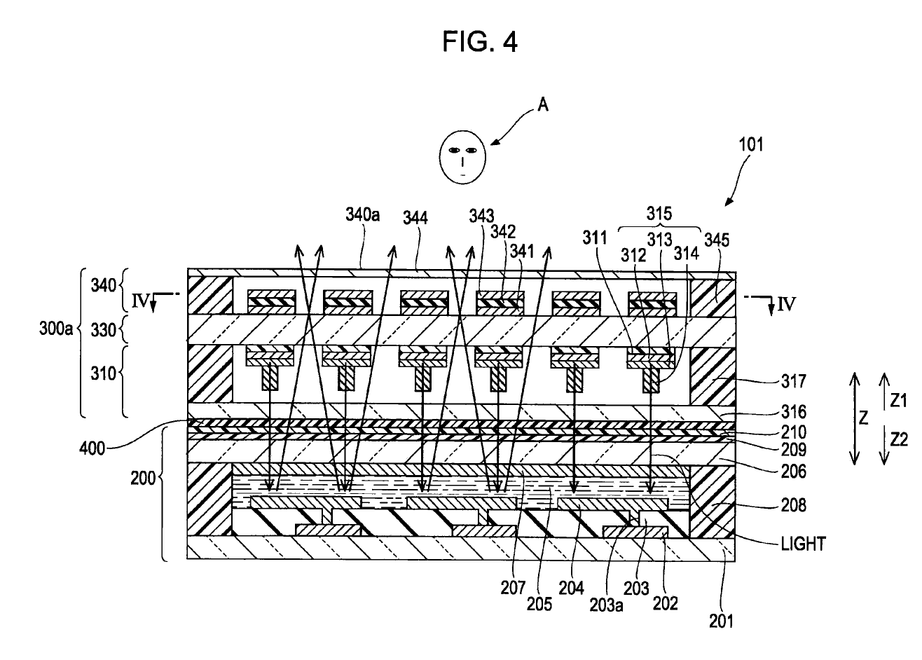

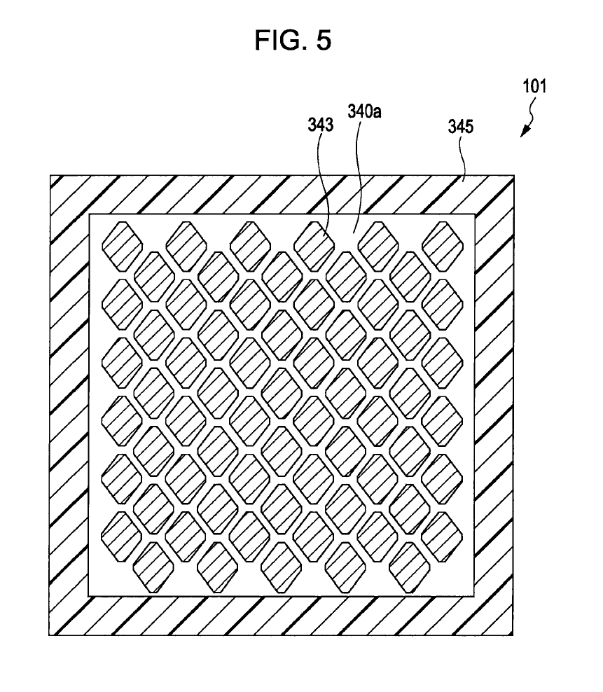

Next, a second embodiment will be described with reference to FIGS. 4 and 5. As opposed to the aforementioned first embodiment, which includes a resistive touch panel 320, the second embodiment describes an input display apparatus 101 that includes an electrostatic capacitance touch panel 340. Note that the electrostatic capacitance touch panel 340 is an example of an “input unit” according to an aspect of the invention.

As shown in FIG. 4, in the electrostatic capacitance touch panel 340 of a front-lit integrated touch panel 300a in the input display apparatus 101 according to the second embodiment, light-transmissible electrode portions 341 configured of a transparent conductive material such as ITO are formed in regions corresponding to a coordinate input surface 340a (see FIG. 5) upon the light-transmissible substrate 330. Note that the front-lit integrated touch panel 300a is an example of an “input apparatus” according to an aspect of the invention, and the light-transmissible electrode portions 341 are examples of a “third electrode layer” according to an aspect of the invention. Insulating films 342 configured of a SiO₂ film (silicon dioxide film) are formed upon the surfaces of the light-transmissible electrode portions 341. Light-transmissible electrode portions 343 configured of a transparent conductive material such as ITO are formed upon the surfaces of the insulating films 342. Note that the light-transmissible electrode portions 343 are an example of a “fourth electrode layer” according to an aspect of the invention.

As seen from the plan view illustrated in FIG. 5, the light-transmissible electrode portions 341, insulating films 342, and light-transmissible electrode portions 343 in FIG. 4 are shaped as rhombuses, and are disposed in a hound's tooth pattern. A protective layer 344 is disposed above the light-transmissible electrode portions 343. Furthermore, the protective layer 344 and the light-transmissible substrate 330 are bonded to each other using a sealant 345 configured of a resin or the like. In the electrostatic capacitance touch panel 340, the configuration is such that when a predetermined voltage is applied across the light-transmissible electrode portions 341 and the light-transmissible electrode portions 343, and the viewer A presses down upon a location on the coordinate input surface 340a with his or her finger, a capacitance is generated (the capacitance changes) between the light-transmissible electrode portions 341 and 343 and the viewer A's finger; accordingly, the location at which the viewer A has pressed down upon the coordinate input surface 340a can be detected by detecting the location of the electrostatic capacitance change using a detection unit (not shown).

Note that the other configurations in the second embodiment are the same as those described above in the first embodiment.

As described above, in the second embodiment, configuring the touch panel 340 to include the light-transmissible electrode portions 341 formed upon the touch panel 340 side of the surface of the light-transmissible substrate 330, which is shared with the front light 310, and the light-transmissible electrode portions 343, which are formed above the light-transmissible electrode portions 341, makes it possible to form an electrostatic capacitance touch panel 340 from the light-transmissible electrode portions 341, which are formed upon the touch panel 340 side of the light-transmissible substrate 330 that is shared between the touch panel 340 and the front light 310, and the light-transmissible electrode portions 343; therefore, it is easy to realize an integrated configuration of the front light 310 and the electrostatic capacitance touch panel 340.

Note that the other effects in the second embodiment are the same as those described above in the first embodiment.

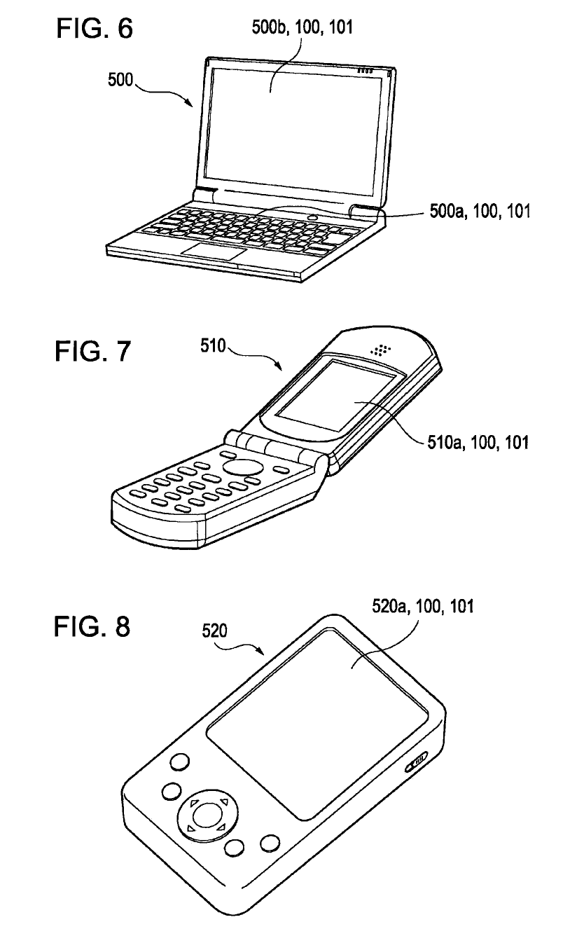

FIGS. 6 through 8 are diagrams illustrating first through third examples of an electronic device that uses the input display apparatuses 100 and 101 according to the first and second embodiments of the invention, respectively. Hereinafter, the configurations of electronic devices that use the input display apparatuses 100 and 101 according to the first and second embodiments of the invention will be described with reference to FIGS. 6 through 8.

As shown in FIGS. 6 through 8, the input display apparatuses 100 and 101 according to the first and second embodiments of the invention can be employed in a PC (Personal Computer) 500, a mobile telephone 510, a mobile information terminal 520 (a PDA, or Personal Digital Assistant), or the like. In the PC 500 shown in FIG. 6, the input display apparatuses 100 and 101 according to the first and second embodiments of the invention can be employed in an input unit 500a, such as a keyboard or the like, a display screen 500b, or the like. In the mobile telephone 510 shown in FIG. 7, the input display apparatuses 100 and 101 according to the first and second embodiments of the invention can be employed in a display screen 510a. In the mobile information terminal 520 shown in FIG. 8, the input display apparatuses 100 and 101 according to the first and second embodiments of the invention can be employed in a display screen 520a.

Note that the descriptions disclosed in the above embodiment are to be understood as being in all ways exemplary and in no way limiting. The scope of the invention is defined by the appended claims rather than the descriptions of the aforementioned embodiments, and many modifications may be made within the same scope as the appended claims.

For example, although the aforementioned first and second embodiments describe an example in which the light-transmissible substrate is configured of a glass substrate, the invention is not limited thereto, and the light-transmissible substrate may be formed from a material aside from glass as long as that material allows light to pass therethrough.

Furthermore, although the aforementioned first and second embodiments describe an example in which a resistive or electrostatic capacitance touch panel is disposed upon a light-transmissible substrate, the invention is not limited thereto, and a touch panel of a type that is not a resistive or electrostatic capacitance type may be disposed instead.

Furthermore, although the aforementioned first and second embodiments describe an example in which a front light using a top emission-type organic EL light source is applied as a front light on the rear side of the light-transmissible substrate, the invention is not limited thereto, and a front light using an organic EL light source that is not the top-emission type, a light-emitting element that is not an organic EL type, or the like may be applied as the front light on the rear side of the light-transmissible substrate instead.

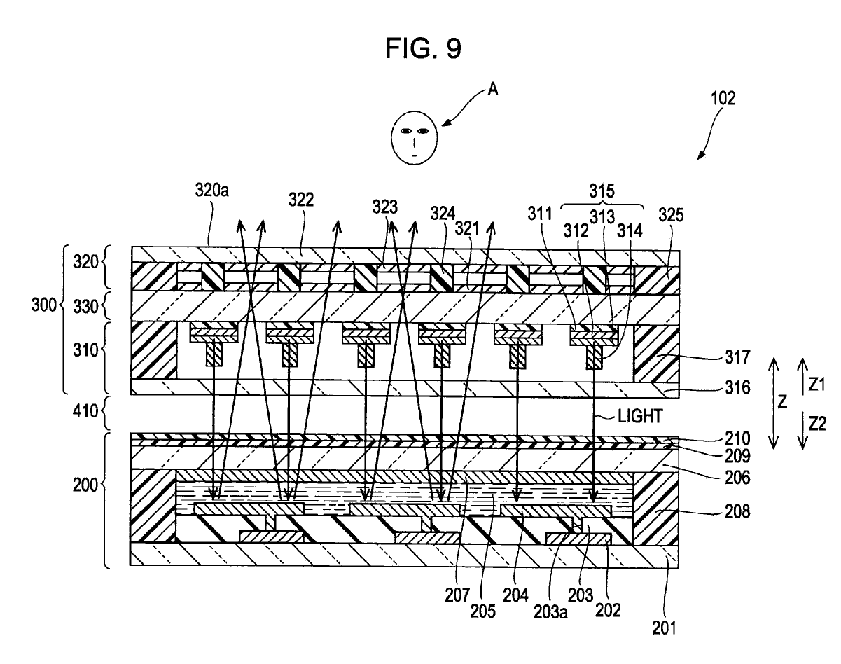

Furthermore, although the aforementioned first and second embodiments describe an example in which the front light and the reflective liquid-crystal display unit are bonded together using a bonding layer, the invention is not limited thereto, and an air layer 410 may be formed between the front light 310 and the reflective liquid-crystal display unit 200 so that a predetermined amount of space is disposed between the front light 310 and the reflective liquid-crystal display unit 200, as with an input display apparatus 102 according to the variation illustrated in FIG. 9.

Furthermore, although the aforementioned first and second embodiments describe employing a reflective liquid-crystal display unit in a display unit as an example of the invention, the invention is not limited thereto, and electronic paper using electrophoresis, an electronic particle fluid, electrowetting, or the like may be applied in the display unit instead.

Furthermore, although the aforementioned first and second embodiments describe employing a reflective liquid-crystal display unit in a display unit as an example of the invention, the invention is not limited thereto, and papers such as posters, analog measurement devices used in vehicles, and so on may be disposed in the display unit.

The entire disclosure of Japanese Patent Application No. 2009-043559, filed Feb. 26, 2009 is expressly incorporated by reference herein.

1. An input apparatus comprising:
a single light-transmissible substrate;
an input unit including a coordinate input surface formed upon one surface of the single light-transmissible substrate; and
an illumination unit formed upon the other surface of the single light-transmissible substrate.

2. The input apparatus according to claim 1,
wherein the illumination unit includes:
a first electrode layer;
a light-emitting layer formed so as to cover the first electrode layer; and
a light-emitting element portion configured of a second electrode layer formed so as to cover the light-emitting layer, and
the light-emitting element portion irradiates light toward the outer side of the single light-transmissible substrate as a result of a predetermined voltage being applied to the first electrode layer and the second electrode layer.

3. The input apparatus according to claim 2,
wherein the first electrode layer is an anode layer;
the second electrode layer is a cathode layer;
the light-emitting layer is an organic light-emitting layer; and
the light-emitting element portion is an organic electroluminescence element configured of the anode layer, the organic light-emitting layer, and the cathode layer.

4. The input apparatus according to claim 1,
wherein the input unit includes:
a third electrode layer; and
a fourth electrode layer formed above the third electrode layer.

5. An input display apparatus comprising:
a liquid-crystal display unit; and
an input apparatus disposed upon the liquid-crystal display unit,
wherein the input apparatus includes:
a single light-transmissible substrate;
an input unit including a coordinate input surface formed upon one surface of the single light-transmissible substrate; and
an illumination unit formed upon the other surface of the single light-transmissible substrate that irradiates light toward the liquid-crystal display unit, and
the liquid-crystal display unit includes:
a reflective display unit that reflects, toward the input apparatus, the light irradiated from the illumination unit.

6. The input display apparatus according to claim 5, further comprising:
a bonding layer for bonding the input apparatus and the single liquid-crystal display unit to each other,
wherein the light-transmissible substrate includes a glass substrate; and
the bonding layer has a refraction index that is approximately the same as the refraction index of the glass substrate.

7. An electronic device comprising the input apparatus according to claim 1.

8. An electronic device comprising the input display apparatus according to claim 5.

9. An electronic device comprising the input apparatus according to claim 2.

10. An electronic device comprising the input apparatus according to claim 3.

11. An electronic device comprising the input apparatus according to claim 4.

12. An electronic device comprising the input display apparatus according to claim 6.
